(19) United States
(12) Patent Application Publication
(10) Pub. No.: US 2025/0096993 A1
(43) Pub. Date: Mar. 20, 2025

(54) USER EQUIPMENT SECONDARY CELL ACTIVATION

(71) Applicant: Nokia Technologies Oy, Espoo (FI)

(72) Inventors: Navin HATHIRAMANI, Dallas, TX (US); Karri Markus RANTA-AHO, Espoo (FI); Benoist Pierre SEBIRE, Tokyo (JP)

(21) Appl. No.: 18/294,438

(22) PCT Filed: Aug. 1, 2022
(86) PCT No.: PCT/EP2022/071549

§ 371 Date: Feb. 1, 2024

Related U.S. Application Data
(60) Provisional application No. 63/229,791, filed on Aug. 5, 2021.

(51) Int. Cl. H04L 5/00; H04L 1/1812; H04W 52/36; H04W 76/28

(52) U.S. Cl. CPC H04L 5/0098; H04L 1/1812; H04W 52/365; H04W 76/28

(57) ABSTRACT

Systems, methods, apparatuses, and computer program products for user equipment (UE) secondary cell (SCell) activation indication are provided. One method may include transmitting a secondary cell (SCell) activation command to at least one user equipment (UE). The secondary cell (SCell) activation command may include an indication of at least one candidate secondary cell (SCell) targeted for activation. The method may also include receiving feedback from the at least one user equipment (UE), wherein the feedback comprises information on the secondary cells (SCells) being activated with reduced activation time.

### FIELD

Some example embodiments may generally relate to communications including mobile or wireless telecommunication systems, such as Long Term Evolution (LTE) or fifth generation (5G) radio access technology or new radio (NR) access technology, or other communications systems. For example, certain example embodiments may generally relate to systems and/or methods for user equipment (UE) secondary cell (SCell) activation indication.

### BACKGROUND

Examples of mobile or wireless telecommunication systems may include the Universal Mobile Telecommunications System (UMTS) Terrestrial Radio Access Network (UTRAN), Long Term Evolution (LTE) Evolved UTRAN (E-UTRAN), LTE-Advanced (LTE-A), MulteFire, LTE-A Pro, and/or fifth generation (5G) radio access technology or new radio (NR) access technology. 5G wireless systems refer to the next generation (NG) of radio systems and network architecture. A 5G system is mostly built on a 5G new radio (NR), but a 5G (or NG) network can also build on the E-UTRA radio. It is estimated that NR provides bitrates on the order of 10-20 Gbit/s or higher, and can support at least service categories such as enhanced mobile broadband (eMBB) and ultra-reliable low-latency-communication (URLLC) as well as massive machine type communication (mMTC). NR is expected to deliver extreme broadband and ultra-robust, low latency connectivity and massive networking to support the Internet of Things (IoT). With IoT and machine-to-machine (M2M) communication becoming more widespread, there will be a growing need for networks that meet the needs of lower power, low data rate, and long battery life. The next generation radio access network (NG-RAN) represents the RAN for 5G, which can provide both NR and LTE (and LTE-Advanced) radio accesses. It is noted that, in 5G, the nodes that can provide radio access functionality to a user equipment (i.e., similar to the Node B, NB, in UTRAN or the evolved NB, eNB, in LTE) may be named next-generation NB (gNB) when built on NR radio and may be named next-generation eNB (NG-eNB) when built on E-UTRA radio.

### SUMMARY

An embodiment may be directed to a method, which may include transmitting, by a network node, a secondary cell (SCell) activation command to at least one user equipment (UE). The secondary cell (SCell) activation command comprises an indication of at least one candidate secondary cell (SCell) targeted for activation. The method may also include receiving feedback from the at least one user equipment (UE), where the feedback comprises information on the secondary cells (SCells) being activated with reduced activation time.

An embodiment may be directed to a method, which may include receiving, by a user equipment (UE), a secondary cell (SCell) activation command from a network node. The secondary cell (SCell) activation command comprises an indication of at least one candidate secondary cell (SCell) targeted for activation. The method may also include determining a set of secondary cells (SCells) requested for activation that are available or preferred for activation, and transmitting feedback to the network node, where the feedback comprises information on the available or preferred secondary cells (SCells) being activated.

An embodiment may be directed to an apparatus that may include at least one processor and at least one memory comprising computer program code. The at least one memory and computer program code configured, with the at least one processor, to cause the apparatus at least to perform: transmitting a secondary cell (SCell) activation command, to at least one user equipment (UE), including an indication of at least one candidate secondary cell (SCell) targeted for activation, and receiving feedback from the at least one user equipment (UE), where the feedback comprises information on the secondary cells (SCells) being activated with reduced activation time.

An embodiment may be directed to an apparatus that may include at least one processor and at least one memory comprising computer program code. The at least one memory and computer program code configured, with the at least one processor, to cause the apparatus at least to perform: receiving a secondary cell (SCell) activation command, from a network node, including an indication of at least one candidate secondary cell (SCell) targeted for activation, determining a set of secondary cells (SCells) requested for activation that are available or preferred for activation, and transmitting feedback to the network node, where the feedback comprises information on the available or preferred secondary cells (SCells) being activated.

An embodiment may be directed to an apparatus that may include means for transmitting a secondary cell (SCell) activation command, to at least one user equipment (UE), including an indication of at least one candidate secondary cell (SCell) targeted for activation, and means for receiving feedback from the at least one user equipment (UE), where the feedback comprises information on the secondary cells (SCells) being activated with reduced activation time.

An embodiment may be directed to an apparatus that may include means for receiving a secondary cell (SCell) activation command, from a network node, including an indication of at least one candidate secondary cell (SCell) targeted for activation, means for determining a set of secondary cells (SCells) requested for activation that are available or preferred for activation, and means for transmitting feedback to the network node, where the feedback comprises information on the available or preferred secondary cells (SCells) being activated.

### BRIEF DESCRIPTION OF THE DRAWINGS

For proper understanding of example embodiments, reference should be made to the accompanying drawings, wherein:

FIG. 1A illustrates an example flow chart of a method, according to an embodiment;

FIG. 1B illustrates an example flow chart of a method, according to an embodiment;

FIG. 2 illustrates an example flow chart of a method, according to an embodiment;

FIG. 3A illustrates an example block diagram of an apparatus, according to an embodiment; and

FIG. 3B illustrates an example block diagram of an apparatus, according to an embodiment.

### DETAILED DESCRIPTION

It will be readily understood that the components of certain example embodiments, as generally described and illustrated in the figures herein, may be arranged and designed in a wide variety of different configurations. Thus, the following detailed description of some example embodiments of systems, methods, apparatuses, and computer program products for a UE SCell activation indication, is not intended to limit the scope of certain embodiments but is representative of selected example embodiments.

The features, structures, or characteristics of example embodiments described throughout this specification may be combined in any suitable manner in one or more example embodiments. For example, the usage of the phrases “certain embodiments,” “some embodiments,” or other similar language, throughout this specification refers to the fact that a particular feature, structure, or characteristic described in connection with an embodiment may be included in at least one embodiment. Thus, appearances of the phrases “in certain embodiments,” “in some embodiments,” “in other embodiments,” or other similar language, throughout this specification do not necessarily all refer to the same group of embodiments, and the described features, structures, or characteristics may be combined in any suitable manner in one or more example embodiments.

Additionally, if desired, the different functions or procedures discussed below may be performed in a different order and/or concurrently with each other. Furthermore, if desired, one or more of the described functions or procedures may be optional or may be combined. As such, the following description should be considered as illustrative of the principles and teachings of certain example embodiments, and not in limitation thereof.

Consideration is currently being given to further multi-radio access technology (RAT) dual-connectivity enhancements. One of the objectives is to support efficient activation/de-activation mechanisms for one secondary cell group (SCG) and secondary cells (SCells). In this respect, support for one SCG applies to (NG) E-UTRAN new radio dual connectivity (EN-DC), and new radio dual connectivity (NR-DC). Support for SCells applies to NR carrier aggregation (CA), and this objective applies to frequency range 1 (FR1) and frequency range 2 (FR2).

Thus far, it has been agreed that the fast activation may be facilitated by the gNB sending a temporary reference signal (RS) burst or two for the UE to quickly achieve synchronization on the to-be-activated SCell. The gNB may send the fast activation and temporary-RS trigger (including indication of the number of temp-RS bursts and their timing) in a medium access control (MAC)-control element (CE) message.

For SCell wake-up a concept of “known” and “unknown” cell plays a major role, as the UE categorizes the cells as known and unknown based on known and specified criteria in 3GPP 38.133, but the actual categorization of any given cell at a given time is not necessarily known at the gNB. It appears likely that the fast SCell activation with temporary RS will take place with known cells, while the unknown cells will take a longer time before being available for scheduling data.

As will be discussed in detail below, certain embodiments provide an Scell activation methodology in which, in the UE, preferred Scells or UE known SCells are targeted for Scell activation by the gNB. In an embodiment, the gNB may send a Scell activation command to the UE indicating candidate SCells that it would like to be activated and informing the UE of the number of Scells that it desires to activate.

In some embodiments, the UE may provide feedback to the gNB on the status of SCells, such as unknown versus known, upon the reception of a MAC CE Scell activation command in which more than one Scell is requested for activation. The UE feedback on preferred SCells and/or the status of the Scells may be provided via layer 1 (L1) or layer 2 (L2) as described in more detail below.

One embodiment may be directed to a L1 based solution. In this embodiment, after receiving the MAC-CE that activates the SCell(s), possibly with temporary RS details, the UE may provide feedback to the gNB that it has correctly received the MAC-CE. In addition, according to an embodiment, the gNB may over book the SCells to activate via the MAC-CE, by indicating more Scells to activate than it desires along with the minimum number of SCells that the UE should activate.

In certain example embodiments, the UE may provide feedback to the gNB with information on which SCells are available for fast activation. According to an embodiment, the information may be sent jointly with the hybrid automatic repeat request (HARQ)-acknowledgement (ACK) of the MAC-CE informing the gNB that the fast SCell activation command was correctly received. For example, the UE may indicate ACK for a (non-existing) physical downlink shared channel (PDSCH) for one or more SCells that are being activated and will be available for fast activation and/or scheduling. As another example, the UE may indicate NACK for a (non-existing) PDSCH for one or more SCells that are being activated and will not be available for fast activation and/or scheduling. Alternatively, the information may be sent in the next channel state information (CSI) feedback to be sent. In one example, the UE may indicate a channel quality indicator (CQI) value for one or more SCells that are being activated, with one CQI value for the SCells that will be available for fast scheduling and another CQI value for those SCells that will not be available for fast scheduling. It is noted that, for an SCell to be available for scheduling, it first has to be activated and then data needs to be scheduled on the SCell for the UE (DL CA) or resources need to be granted for UE UL transmissions (UL CA).

According to certain embodiments, cells available for fast activation and/or scheduling may include cells that have reduced activation time. In other words, the feedback may include information on the SCells with reduced activation time, for example, based on the UE status for the SCell in terms of synchronization, whether the SCell is known to the UE, and/or automatic gain control (AGC) (e.g., whether SCell AGC fine tuning is required for the SCell). Thus, in an example embodiment, the criterion for a UE determining a cell to have reduced activation time may include the cell being a known cell to the UE.

It is further noted that, for the HARQ-ACK usage, the HARQ-ACK codebook for carrier aggregation allows for indicating HARQ-ACK for each SCell. Normally, when an SCell is inactive, the cells are not considered in the HARQ-ACK codebook generation. However, in this case, for the HARQ-ACK for the MAC-CE, an exception may be made such that the configured SCells (and not just active SCells) can be considered in the codebook generation.

For the CQI usage, the UE would normally only send a CQI after it has received a CSI-RS for the cell-to-be-activated. However, according to an embodiment, an exception is provided such that a CQI report for the configured SCells (active or inactive) can be sent after the reception of the SCell MAC-CE activation command. In this embodiment, the CQI value would not indicate any practical CQI as there is no measurement related to the reporting, but would include an indication of “known” or “unknown” SCells. For example, in one embodiment, a CQI-0 may be used for “unknown” and CQI=1 could be used for “known” cells, or vice versa.

The benefit of certain example embodiments includes that the gNB would know in advance which cells are available and can start the upper layer processes for mapping data on the carriers that will be soon ready to accept traffic. It is noted that, from a gNB perspective, data has to be populated in the buffers of each SCell. If the gNB is not aware of which SCells will be activated, then this could cause delays and/or retransmissions negatively impacting the end user experience and is counterproductive to the goal of reduced SCell activation time. In some cases, example embodiments can also reduce or save the overhead of temporary RS.

An example embodiment may be directed to a L2 based solution. In this embodiment, after receiving the MAC-CE that activates the SCell(s) with temporary RS, the UE may provide feedback to the gNB that it has correctly received the MAC-CE. According to an embodiment, the gNB may over book the SCells to activate MAC-CE, e.g., by indicating more SCells to activate than the gNB desires along with the minimum number of SCells that the UE should activate. In one embodiment, the gNB may include an uplink (UL) grant along with the MAC CE SCell activation command. According to certain embodiments, the UE may employ the UL grant to provide L2 feedback to the gNB with information on which SCells are available for reduced activation time (e.g., SCell known vs unknown) and/or information on the UE's preferred list of SCells to be activated.

In some embodiments, the L2 feedback may include a new MAC CE with a bitmap for each SCell configured such that: Ci field set to 1 indicates that the SCell is available with reduced activation time and Ci field set to 0 indicates that the SCell is not available with reduced activation time, where i corresponds to ServCellIndex i (e.g., as specified in 3GPP TS 38.331). According to some embodiments, the new MAC-CE may be triggered upon SCell activation.

Alternatively or additionally, in an embodiment, since the power headroom (PHR) is triggered upon SCell activation, the L2 feedback may include a modified PHR or modified PHR trigger. For instance, the modified PHR may carry the bitmap discussed above. The modified trigger may first trigger a PHR for the SCells that are available with reduced activation time, and then another one for the activated SCells.

Further, in an embodiment, a UE may provide periodical or event based feedback on SCell status, e.g., known versus unknown, or SCell activation preference via MAC-CE. In one embodiment, this SCell status MAC-CE may be included in addition to or in combination with padding buffer status report (BSR) in certain scenarios. For example, these certain scenarios may include where the UE has been in DRX active time receiving DL data for the last XX slots, where XX could be semi-statically configured or set in the standards. As another example, the certain scenarios may include when the UE received dynamically scheduled DL data in the last XX slots in which the employed coding rate and MIMO transmission mode is close to the one it reported by CSI feedback. Benefits of this periodic/event reporting may include a method for the UE to drive its preferred component carriers (CC) to be activated to, e.g., avoid overheating.

It should be noted that the L1 and L2 based solutions may be implemented separately or combined, according to some example embodiments. In other words, some embodiments may implement both the L1 and L2 based solutions or any subset thereof. According to some embodiments, whether a L1, L2, or both a L1 and L2 solution are to be followed by the UE can be explicitly configured by the network (either per UE or per SCell per UE).

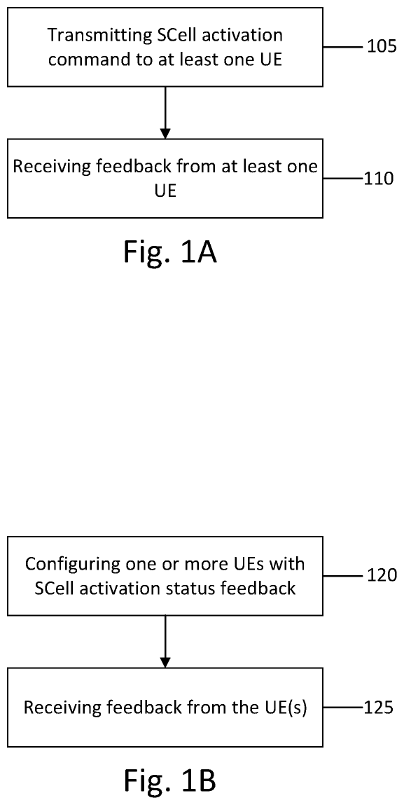

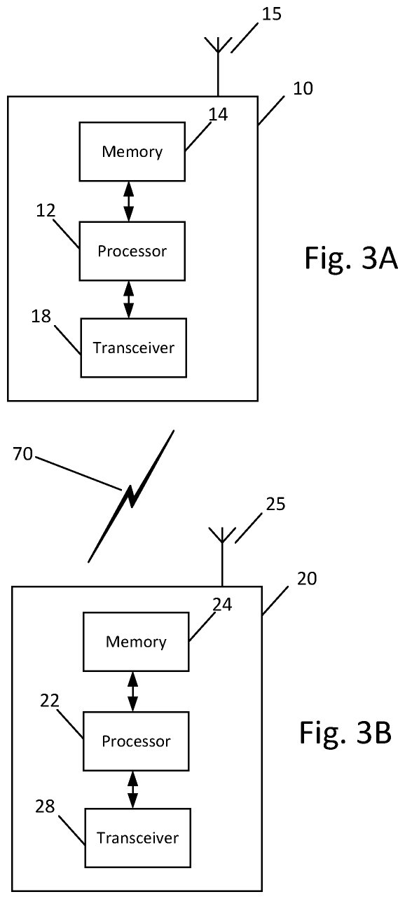

FIG. 1A illustrates an example flow diagram of a method for UE SCell activation indication, according to an example embodiment. In certain example embodiments, the flow diagram of FIG. 1A may be performed by a network entity or network node in a communications system, such as LTE or 5G NR. In some example embodiments, the network entity performing the method of FIG. 1 may include or be included in a base station, access node, node B, eNB, gNB, NG-RAN node, transmission-reception points (TRPs), high altitude platform stations (HAPS), relay station or the like. In some embodiments, the example of FIG. 1A may illustrate example operations of a network node or gNB corresponding to apparatus 10 as illustrated in, and described with respect to, FIG. 3A.

As illustrated in the example of FIG. 1A, the method may include, at 105, transmitting SCell activation command from a network node to at least one UE. For example, the SCell activation command may include one or multiple MAC-CEs. In one embodiment, the SCell activation command may include an indication of one or more SCells that are targeted for activation. For instance, the SCell activation command may include an indication of the candidate SCells that the network node would like to be activated and/or the number of SCells that the network node seeks to activate. In certain embodiments, the transmitting 105 may include indicating more SCells to activate than needed (e.g., overbooking the SCells to activate via the MAC-CE), along with the minimum number of SCells that the UE should activate. According to an embodiment, the transmitting 105 may include providing an UL grant along with the SCell activation command.

In an embodiment, the method of FIG. 1A may include, at 110, receiving feedback, from the at least one UE, including information on the set of SCells being activated with reduced activation time. For example, the SCells being activated that have reduced activation time may include SCells that are known to the UE. In one embodiment, the information on the secondary cells (SCells) being activated may include or may be included in a PHR. For example, a PHR may be triggered at activation and can be used to identify which SCell(s) were activated, as discussed in more detail below.

According to an embodiment, the receiving of the feedback 110 may include receiving the information jointly with the HARQ-ACK of the SCell activation command informing the network node that the SCell activation command was correctly received. For example, the network node may receive, from the at least one UE, an ACK for a (non-existing) PDSCH for one or more SCells that are being activated and will be available with reduced activation time, and/or receive NACK for a (non-existing) PDSCH for one or more SCells that are being activated and will not be available with reduced activation time.

In another embodiment, the receiving of the feedback 110 may include receiving the information in the next CSI feedback to be sent by the at least one UE. In one example, the receiving 110 may include receiving, from the UE, a CQI value for one or more SCells that are being activated, with one CQI value for the SCells that will be available with reduced activation time and another CQI value for those SCells that will not be available with reduced activation time.

In yet another embodiment, if an UL grant is provided, along with the SCell activation command, the receiving of the feedback 110 may include receiving, via the UL grant, L2 feedback from the UE with information on which SCells are available for activation (e.g., known versus unknown SCell) and/or the UE's preferred list of SCells to be activated. In one embodiment, the information on which SCells are available for activation, as provided in the L2 feedback, may include information on the SCells that have reduced activation time. In other words, the feedback may include information on the SCells available with reduced activation time, such as SCells with reduced activation time, for example, based on the UE status for the SCell in terms of synchronization, whether the SCell is known to the UE, and/or automatic gain control (AGC) (e.g., whether SCell AGC fine tuning is required for the SCell).

In some embodiments, the L2 feedback may include a MAC CE with a bitmap for each SCell configured. According to an embodiment, each field of the bitmap may indicate available or preferred SCells for activation. For example, in the bitmap, Ci field set to 1 may indicate that the SCell is available with reduced activation time and Ci field set to 0 may indicate that the SCell is not available with reduced activation time, where i corresponds to a serving cell index i (e.g., ServCellIndex i as specified in 3GPP TS 38.331). According to some embodiments, the new MAC CE may be triggered upon SCell activation.

Alternatively or additionally, in an embodiment, as the PHR is triggered upon SCell activation, the L2 feedback may include a modified PHR or modified PHR trigger. According to certain embodiments, the PHR may include information on available or preferred SCells for activation. For example, in one embodiment the modified PHR may carry the bitmap discussed above. In certain embodiments, the modified PHR trigger may first trigger a PHR for the SCells that are available with reduced activation time, and then another one for the activated SCells.

Further, in an embodiment, the receiving of the L2 feedback 110 may include receiving periodical or event based feedback on SCell status, e.g., known versus unknown, or SCell activation preference via MAC-CE. In one embodiment, this SCell status MAC-CE may be included in addition to or in combination with padding BSR in certain scenarios. As one example, the certain scenarios may include where the UE has been in DRX active time receiving DL data for the last XX slots, where XX could be semi-statically configured or set in the standards. As another example, the certain scenarios may include when the UE received dynamically scheduled DL data in the last XX slots in which the employed coding rate and MIMO transmission mode is close to the one it reported by CSI feedback.

FIG. 1B illustrates an example flow diagram of a method for UE SCell activation indication, according to an example embodiment. In certain example embodiments, the flow diagram of FIG. 1B may be performed by a network entity or network node in a communications system, such as LTE or 5G NR. In some example embodiments, the network entity performing the method of FIG. 1B may include or be included in a base station, access node, node B, eNB, gNB, NG-RAN node, transmission-reception points (TRPs), high altitude platform stations (HAPS), relay station or the like. In some embodiments, the example of FIG. 1B may illustrate example operations of a network node or gNB corresponding to apparatus 10 as illustrated in, and described with respect to, FIG. 3A.

As illustrated in the example of FIG. 1B, the method may include, at 120, configuring one or more UEs with SCell activation status feedback. For instance, the configuring 120 may include configuring the UE(s) to provide event based feedback. As further illustrated in the example of FIG. 1B, the method may then include, at 125, receiving feedback from the UE(s). In an embodiment, the receiving 125 may include receiving the event based feedback from the UE(s) in a MAC-CE as padding when the allocated resources are larger than the data available. According to one embodiment, the UE(s) may prioritize the feedback based on the UE(s) duration in discontinuous reception (DRX) active time and estimation of the needs for higher DL or UL capacity, for example, UL BSR or number average DL RLC size SDU in the last XX slots.

FIGS. 1A and 1B are provided as some examples of a method, according to certain embodiments. Other examples are possible as one or more procedures discussed above or illustrated in FIGS. 1A and/or 1B may be skipped or may be performed in a different order, or additional procedures may be added. Additionally, according to certain embodiments, the procedures depicted in FIGS. 1A and 1B may be combined.

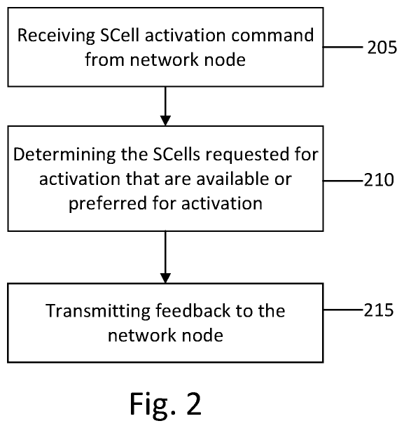

FIG. 2 illustrates an example flow diagram of a method of UE SCell activation indication, according to one example embodiment. In certain example embodiments, the flow diagram of FIG. 2 may be performed by a network entity or network node in a communications system, such as LTE or 5G NR. For instance, in some example embodiments, the network entity performing the method of FIG. 2 may include a UE, sidelink (SL) UE, mobile station, IoT device, UE type of roadside unit (RSU), other mobile or stationary device, or the like. In some embodiments, the example of FIG. 2 may illustrate example operations of a UE corresponding to apparatus 20 as illustrated in, and described with respect to, FIG. 3B.

As illustrated in the example of FIG. 2, the method may include, 205, receiving SCell activation command from a network node (e.g., gNB). In some embodiments, the SCell activation command may include one or multiple MAC-CEs. In one embodiment, the SCell activation command may include an indication of at least one SCell targeted for activation. For example, the SCell activation command may include an indication of the candidate SCells that the network node would like to be activated and/or the number of SCells that the network node seeks to activate. In certain embodiments, the network node may overbook the SCells to activate via the SCell activation command by indicating more SCells to activate than needed, along with the minimum number of SCells the UE should activate. According to an embodiment, the receiving 205 may include receiving an UL grant along with the SCell activation command or MAC-CE(s).

In an embodiment, the method of FIG. 2 may include, at 210, determining the set of SCells requested for activation that are available or preferred for activation. According to some embodiments, the determining 210 may include determining each SCell activation time and prioritizing the SCells with reduced activation time based on the SCell status. For example, SCells may be considered available with reduced activation time when the SCell is a known cell to the UE. The method may further include, at 215, transmitting feedback, to the network node, including information on the determined available or preferred SCells being activated. In other words, in an embodiment, the feedback may include information on the SCells with reduced activation time, for example, based on the UE status for the SCell in terms of synchronization, whether the SCell is known to the UE, and/or automatic gain control (AGC) (e.g., whether SCell AGC fine tuning is required for the SCell). Thus, in an embodiment, the SCell status may include whether a SCell is a known cell to the UE.

In an embodiment, the providing feedback 215 may include providing the information jointly with the HARQ-ACK of the SCell activation command, informing the network node that the SCell activation command was correctly received. For example, the UE may indicate ACK for a (non-existing) PDSCH for one or more SCells that are being activated and will be available with reduced activation time, and/or the UE may indicate NACK for a (non-existing) PDSCH for one or more SCells that are being activated and will not be available with reduced activation time.

In another embodiment, the providing feedback 215 may include providing the information in the next CSI feedback to be sent by the UE. In on example, the UE may indicate a CQI value for one or more SCells that are being activated, with one CQI value for the SCells that will be available with reduced activation time and another CQI value for those SCells that will not be with reduced activation time.

In yet another embodiment, if an UL grant is received along with the MAC-CE SCell activation command, the providing feedback 215 may include employing the UL grant to provide L2 feedback to the network node with information on which SCells are available for activation (e.g., known versus unknown SCell) and/or the UE's preferred list of SCells to be activated.

In some embodiments, the L2 feedback may include a MAC CE with a bitmap for each SCell configured. According to an embodiment, each field of the bitmap may indicate available or preferred SCells for activation. For example, in the bitmap, Ci field set to 1 may indicate that the SCell is available with reduced activation time and Ci field set to 0 may indicate that the SCell is not available with reduced activation time, where i corresponds to a serving cell index i (e.g., ServCellIndex i as specified in 3GPP TS 38.331). According to some embodiments, the new MAC CE may be triggered upon SCell activation.

Alternatively or additionally, in an embodiment, as the PHR is triggered upon SCell activation, the L2 feedback may include a modified PHR or modified PHR trigger. According to an embodiment, the PHR may include information on available or preferred SCells for activation. For example, in one embodiment the modified PHR may carry the bitmap discussed above. In certain embodiments, the modified PHR trigger may first trigger a PHR for the SCells that are available with reduced activation time, and then another one for the activated SCells.

Further, in an embodiment, the providing of feedback at 215 may include providing periodical or event based feedback on SCell status, e.g., known versus unknown, or SCell activation preference via MAC-CE. In one embodiment, this SCell status MAC-CE may be included in addition to or in combination with padding BSR in certain scenarios. As one example, the certain scenarios may include where the UE has been in DRX active time receiving DL data for the last XX slots, where XX could be semi-statically configured or set in the standards. As another example, the certain scenarios may include when the UE received dynamically scheduled DL data in the last XX slots in which the employed coding rate and MIMO transmission mode is close to the one it reported by CSI feedback.

FIG. 2 is provided as one example of a method, according to certain embodiments. Other examples are possible as one or more procedures discussed above or illustrated in FIG. 2 may be skipped or may be performed in a different order, or additional procedures may be added.

FIG. 3A illustrates an example of an apparatus 10 according to an embodiment. In an embodiment, apparatus 10 may be a node, host, or server in a communications network or serving such a network. For example, apparatus 10 may be a network node, a sensing node, satellite, base station, a Node B, an evolved Node B (eNB), 5G Node B or access point, next generation Node B (NG-NB or gNB), TRP, HAPS, integrated access and backhaul (IAB) node, and/or a WLAN access point, associated with a radio access network, such as a LTE network, 5G or NR. In some example embodiments, apparatus 10 may be gNB or other similar radio node, for instance.

It should be understood that, in some example embodiments, apparatus 10 may be comprised of an edge cloud server as a distributed computing system where the server and the radio node may be stand-alone apparatuses communicating with each other via a radio path or via a wired connection, or they may be located in a same entity communicating via a wired connection. For instance, in certain example embodiments where apparatus 10 represents a gNB, it may be configured in a central unit (CU) and distributed unit (DU) architecture that divides the gNB functionality. In such an architecture, the CU may be a logical node that includes gNB functions such as transfer of user data, mobility control, radio access network sharing, positioning, and/or session management, etc. The CU may control the operation of DU(s) over a front-haul interface. The DU may be a logical node that includes a subset of the gNB functions, depending on the functional split option. It should be noted that one of ordinary skill in the art would understand that apparatus 10 may include components or features not shown in FIG. 3A.

As illustrated in the example of FIG. 3A, apparatus 10 may include a processor 12 for processing information and executing instructions or operations. Processor 12 may be any type of general or specific purpose processor. In fact, processor 12 may include one or more of general-purpose computers, special purpose computers, microprocessors, digital signal processors (DSPs), field-programmable gate arrays (FPGAs), application-specific integrated circuits (ASICs), and processors based on a multi-core processor architecture, or any other processing means, as examples. While a single processor 12 is shown in FIG. 3A, multiple processors may be utilized according to other embodiments. For example, it should be understood that, in certain embodiments, apparatus 10 may include two or more processors that may form a multiprocessor system (e.g., in this case processor 12 may represent a multiprocessor) that may support multiprocessing. In certain embodiments, the multiprocessor system may be tightly coupled or loosely coupled (e.g., to form a computer cluster).

Processor 12 may perform functions associated with the operation of apparatus 10, which may include, for example, precoding of antenna gain/phase parameters, encoding and decoding of individual bits forming a communication message, formatting of information, and overall control of the apparatus 10, including processes related to management of communication or communication resources.

Apparatus 10 may further include or be coupled to a memory 14 (internal or external), which may be coupled to processor 12, for storing information and instructions that may be executed by processor 12. Memory 14 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 14 can be comprised of any combination of random access memory (RAM), read only memory (ROM), static storage such as a magnetic or optical disk, hard disk drive (HDD), or any other type of non-transitory machine or computer readable media, or other appropriate storing means. The instructions stored in memory 14 may include program instructions or computer program code that, when executed by processor 12, enable the apparatus 10 to perform tasks as described herein.

In an embodiment, apparatus 10 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 12 and/or apparatus 10.

In some embodiments, apparatus 10 may also include or be coupled to one or more antennas 15 for transmitting and receiving signals and/or data to and from apparatus 10. Apparatus 10 may further include or be coupled to a transceiver 18 configured to transmit and receive information. The transceiver 18 may include, for example, a plurality of radio interfaces that may be coupled to the antenna(s) 15, or may include any other appropriate transceiving means. The radio interfaces may correspond to a plurality of radio access technologies including one or more of GSM, NB-IoT, LTE, 5G, WLAN, Bluetooth, BT-LE, NFC, radio frequency identifier (RFID), ultrawideband (UWB), MulteFire, and the like. The radio interface may include components, such as filters, converters (for example, digital-to-analog converters and the like), mappers, a Fast Fourier Transform (FFT) module, and the like, to generate symbols for a transmission via one or more downlinks and to receive symbols (via an uplink, for example).

As such, transceiver 18 may be configured to modulate information on to a carrier waveform for transmission by the antenna(s) 15 and demodulate information received via the antenna(s) 15 for further processing by other elements of apparatus 10. In other embodiments, transceiver 18 may be capable of transmitting and receiving signals or data directly. Additionally or alternatively, in some embodiments, apparatus 10 may include an input and/or output device (I/O device), or an input/output means.

In an embodiment, memory 14 may store software modules that provide functionality when executed by processor 12. The modules may include, for example, an operating system that provides operating system functionality for apparatus 10. The memory may also store one or more functional modules, such as an application or program, to provide additional functionality for apparatus 10. The components of apparatus 10 may be implemented in hardware, or as any suitable combination of hardware and software.

According to some embodiments, processor 12 and memory 14 may be included in or may form a part of processing circuitry/means or control circuitry/means. In addition, in some embodiments, transceiver 18 may be included in or may form a part of transceiver circuitry/means.

As used herein, the term “circuitry” may refer to hardware-only circuitry implementations (e.g., analog and/or digital circuitry), combinations of hardware circuits and software, combinations of analog and/or digital hardware circuits with software/firmware, any portions of hardware processor(s) with software (including digital signal processors) that work together to cause an apparatus (e.g., apparatus 10) to perform various functions, and/or hardware circuit(s) and/or processor(s), or portions thereof, that use software for operation but where the software may not be present when it is not needed for operation. As a further example, as used herein, the term “circuitry” may also cover an implementation of merely a hardware circuit or processor (or multiple processors), or portion of a hardware circuit or processor, and its accompanying software and/or firmware. The term circuitry may also cover, for example, a baseband integrated circuit in a server, cellular network node or device, or other computing or network device.

As introduced above, in certain embodiments, apparatus 10 may be or may be a part of a network element or RAN node, such as a base station, access point, Node B, eNB, gNB, TRP, HAPS, IAB node, WLAN access point, or the like. In one example embodiment, apparatus 10 may be a gNB or other radio node, or may be a CU and/or DU of a gNB. According to certain embodiments, apparatus 10 may be controlled by memory 14 and processor 12 to perform the functions associated with any of the embodiments described herein. For example, in some embodiments, apparatus 10 may be configured to perform one or more of the processes depicted in any of the flow charts or signaling diagrams described herein, such as those illustrated in FIGS. 1-2, or any other method described herein. In some embodiments, as discussed herein, apparatus 10 may be configured to perform a procedure relating to the indication of UE SCell activation, for example.

FIG. 3B illustrates an example of an apparatus 20 according to another embodiment. In an embodiment, apparatus 20 may be a node or element in a communications network or associated with such a network, such as a UE, communication node, mobile equipment (ME), mobile station, mobile device, stationary device, IoT device, or other device. As described herein, a UE may alternatively be referred to as, for example, a mobile station, mobile equipment, mobile unit, mobile device, user device, subscriber station, wireless terminal, tablet, smart phone, IoT device, sensor or NB-IoT device, a watch or other wearable, a head-mounted display (HMD), a vehicle, a drone, a medical device and applications thereof (e.g., remote surgery), an industrial device and applications thereof (e.g., a robot and/or other wireless devices operating in an industrial and/or an automated processing chain context), a consumer electronics device, a device operating on commercial and/or industrial wireless networks, or the like. As one example, apparatus 20 may be implemented in, for instance, a wireless handheld device, a wireless plug-in accessory, or the like.

In some example embodiments, apparatus 20 may include one or more processors, one or more computer-readable storage medium (for example, memory, storage, or the like), one or more radio access components (for example, a modem, a transceiver, or the like), and/or a user interface. In some embodiments, apparatus 20 may be configured to operate using one or more radio access technologies, such as GSM, LTE, LTE-A, NR, 5G, WLAN, WiFi, NB-IoT, Bluetooth, NFC, MulteFire, and/or any other radio access technologies. It should be noted that one of ordinary skill in the art would understand that apparatus 20 may include components or features not shown in FIG. 3B.

As illustrated in the example of FIG. 3B, apparatus 20 may include or be coupled to a processor 22 for processing information and executing instructions or operations. Processor 22 may be any type of general or specific purpose processor. In fact, processor 22 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While a single processor 22 is shown in FIG. 3B, multiple processors may be utilized according to other embodiments. For example, it should be understood that, in certain embodiments, apparatus 20 may include two or more processors that may form a multiprocessor system (e.g., in this case processor 22 may represent a multiprocessor) that may support multiprocessing. In certain embodiments, the multiprocessor system may be tightly coupled or loosely coupled (e.g., to form a computer cluster).

Processor 22 may perform functions associated with the operation of apparatus 20 including, as some examples, precoding of antenna gain/phase parameters, encoding and decoding of individual bits forming a communication message, formatting of information, and overall control of the apparatus 20, including processes related to management of communication resources.

Apparatus 20 may further include or be coupled to a memory 24 (internal or external), which may be coupled to processor 22, for storing information and instructions that may be executed by processor 22. Memory 24 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 24 can be comprised of any combination of random access memory (RAM), read only memory (ROM), static storage such as a magnetic or optical disk, hard disk drive (HDD), or any other type of non-transitory machine or computer readable media. The instructions stored in memory 24 may include program instructions or computer program code that, when executed by processor 22, enable the apparatus 20 to perform tasks as described herein.

In an embodiment, apparatus 20 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 22 and/or apparatus 20.

In some embodiments, apparatus 20 may also include or be coupled to one or more antennas 25 for receiving a downlink signal and for transmitting via an uplink from apparatus 20. Apparatus 20 may further include a transceiver 28 configured to transmit and receive information. The transceiver 28 may also include a radio interface (e.g., a modem) coupled to the antenna 25. The radio interface may correspond to a plurality of radio access technologies including one or more of GSM, LTE, LTE-A, 5G, NR, WLAN, NB-IoT, Bluetooth, BT-LE, NFC, RFID, UWB, and the like. The radio interface may include other components, such as filters, converters (for example, digital-to-analog converters and the like), symbol demappers, signal shaping components, an Inverse Fast Fourier Transform (IFFT) module, and the like, to process symbols, such as OFDMA symbols, carried by a downlink or an uplink.

For instance, transceiver 28 may be configured to modulate information on to a carrier waveform for transmission by the antenna(s) 25 and demodulate information received via the antenna(s) 25 for further processing by other elements of apparatus 20. In other embodiments, transceiver 28 may be capable of transmitting and receiving signals or data directly. Additionally or alternatively, in some embodiments, apparatus 20 may include an input and/or output device (I/O device). In certain embodiments, apparatus 20 may further include a user interface, such as a graphical user interface or touchscreen.

In an embodiment, memory 24 stores software modules that provide functionality when executed by processor 22. The modules may include, for example, an operating system that provides operating system functionality for apparatus 20. The memory may also store one or more functional modules, such as an application or program, to provide additional functionality for apparatus 20. The components of apparatus 20 may be implemented in hardware, or as any suitable combination of hardware and software. According to an example embodiment, apparatus 20 may optionally be configured to communicate with apparatus 10 via a wireless or wired communications link 70 according to any radio access technology, such as NR.

According to some embodiments, processor 22 and memory 24 may be included in or may form a part of processing circuitry or control circuitry. In addition, in some embodiments, transceiver 28 may be included in or may form a part of transceiving circuitry.

As discussed above, according to some embodiments, apparatus 20 may be a UE, SL UE, relay UE, mobile device, mobile station, ME, IoT device and/or NB-IoT device, or the like, for example. According to certain embodiments, apparatus 20 may be controlled by memory 24 and processor 22 to perform the functions associated with any of the embodiments described herein, such as one or more of the operations illustrated in, or described with respect to, FIGS. 1-2, or any other method described herein. For example, in an embodiment, apparatus 20 may be controlled to perform a process relating to the indication of UE SCell activation, as described in detail elsewhere herein.

In some embodiments, an apparatus (e.g., apparatus 10 and/or apparatus 20) may include means for performing a method, a process, or any of the variants discussed herein. Examples of the means may include one or more processors, memory, controllers, transmitters, receivers, and/or computer program code for causing the performance of any of the operations discussed herein.

In view of the foregoing, certain example embodiments provide several technological improvements, enhancements, and/or advantages over existing technological processes and constitute an improvement at least to the technological field of wireless network control and/or management. For example, as discussed in detail above, certain embodiments provide ways to allow a gNB to know in advance which cells are available and can start the upper layer processes for mapping data on the carriers that soon be ready to accept traffic. As a result, example embodiments can reduce delays and/or retransmissions that would otherwise negatively impact the end user experience. Additionally, some embodiments can reduce temporary RS overhead. Accordingly, the use of certain example embodiments results in improved functioning of communications networks and their nodes, such as base stations, eNBs, gNBs, and/or IoT devices, UEs or mobile stations.

In some example embodiments, the functionality of any of the methods, processes, signaling diagrams, algorithms or flow charts described herein may be implemented by software and/or computer program code or portions of code stored in memory or other computer readable or tangible media, and may be executed by a processor.

In some example embodiments, an apparatus may include or be associated with at least one software application, module, unit or entity configured as arithmetic operation(s), or as a program or portions of programs (including an added or updated software routine), which may be executed by at least one operation processor or controller. Programs, also called program products or computer programs, including software routines, applets and macros, may be stored in any apparatus-readable data storage medium and may include program instructions to perform particular tasks. A computer program product may include one or more computer-executable components which, when the program is run, are configured to carry out some example embodiments. The one or more computer-executable components may be at least one software code or portions of code. Modifications and configurations required for implementing the functionality of an example embodiment may be performed as routine(s), which may be implemented as added or updated software routine(s). In one example, software routine(s) may be downloaded into the apparatus.

As an example, software or computer program code or portions of code may be in source code form, object code form, or in some intermediate form, and may be stored in some sort of carrier, distribution medium, or computer readable medium, which may be any entity or device capable of carrying the program. Such carriers may include a record medium, computer memory, read-only memory, photoelectrical and/or electrical carrier signal, telecommunications signal, and/or software distribution package, for example. Depending on the processing power needed, the computer program may be executed in a single electronic digital computer or it may be distributed amongst a number of computers. The computer readable medium or computer readable storage medium may be a non-transitory medium.

In other example embodiments, the functionality of example embodiments may be performed by hardware or circuitry included in an apparatus, for example through the use of an application specific integrated circuit (ASIC), a programmable gate array (PGA), a field programmable gate array (FPGA), or any other combination of hardware and software. In yet another example embodiment, the functionality of example embodiments may be implemented as a signal, such as a non-tangible means, that can be carried by an electromagnetic signal downloaded from the Internet or other network.

According to an example embodiment, an apparatus, such as a node, device, or a corresponding component, may be configured as circuitry, a computer or a microprocessor, such as single-chip computer element, or as a chipset, which may include at least a memory for providing storage capacity used for arithmetic operation(s) and/or an operation processor for executing the arithmetic operation(s).

Example embodiments described herein may apply to both singular and plural implementations, regardless of whether singular or plural language is used in connection with describing certain embodiments. For example, an embodiment that describes operations of a single network node may also apply to example embodiments that include multiple instances of the network node, and vice versa.

One having ordinary skill in the art will readily understand that the example embodiments as discussed above may be practiced with procedures in a different order, and/or with hardware elements in configurations which are different than those which are disclosed. Therefore, although some embodiments have been described based upon these example embodiments, it would be apparent to those of skill in the art that certain modifications, variations, and alternative constructions would be apparent, while remaining within the spirit and scope of example embodiments.

1-56. (canceled)

57. An apparatus, comprising:
at least one processor; and
at least one memory comprising computer program code,
the at least one memory and computer program code configured, with the at least one processor, to cause the apparatus at least to perform:
transmitting a secondary cell (SCell) activation command to at least one user equipment (UE), wherein the secondary cell (SCell) activation command comprises an indication of at least one candidate secondary cell (SCell) targeted for activation; and
receiving feedback from the at least one user equipment (UE), wherein the feedback comprises information on the secondary cells (SCells) being activated with reduced activation time.

58. The apparatus of claim 57, wherein the transmitting comprises indicating more secondary cells (SCells) to activate than needed, along with a minimum number of secondary cells (SCells) that the at least one user equipment (UE) should activate.

59. The apparatus of claim 57, wherein the transmitting comprises providing an uplink grant with the secondary cell (SCell) activation command.

60. The apparatus of claim 57, wherein the secondary cell (SCell) activation command comprises a single or multiple medium access control (MAC)-control elements (CEs).

61. The apparatus of claim 57, wherein the receiving of the feedback comprises receiving the information jointly with a hybrid automatic repeat request (HARQ)-acknowledgment (ACK) of the secondary cell (SCell) activation command, informing the network node that the secondary cell (SCell) activation command was correctly received.

62. The apparatus of claim 57, wherein the receiving of the feedback comprises receiving, via the uplink grant, layer 2 (L2) feedback from the at least one user equipment (UE) with information on at least one of the secondary cells (SCells) that are available for activation or the at least one user equipment's preferred list of secondary cells (SCells) to be activated.

63. The apparatus of claim 62, wherein the L2 feedback comprises:
a medium access control (MAC)-control element (CE) comprising a bitmap for each secondary cell (SCell) configured wherein each field of the bitmap indicates available or preferred secondary cells (SCells) for activation.

64. The apparatus of claim 62, wherein the L2 feedback comprises:
a modified power headroom report (PHR) or modified power headroom report (PHR) trigger, wherein the power headroom report (PHR) comprises information on available or preferred secondary cells (SCells) for activation.

65. The apparatus of claim 57, wherein the receiving of the L2 feedback comprises receiving periodical or event based feedback on secondary cell (SCell) status or secondary cell (SCell) activation preference via medium access control (MAC)-control element (CE).

66. The apparatus of claim 65, wherein the receiving of the event based feedback comprises receiving the event based feedback in the medium access control (MAC)-control element (CE) as padding when allocated resources are larger than available data.

67. The apparatus of claim 65, wherein the user equipment (UE) is configured to prioritize the feedback based on its duration in discontinuous (DRX) active time and estimation of a need for higher downlink (DL) or uplink (UL) capacity.

68. The apparatus of claim 57, wherein the secondary cells (SCells) being activated with reduced activation time comprise secondary cells (SCells) that are known to the user equipment (UE).

69. An apparatus, comprising:
at least one processor; and
at least one memory comprising computer program code,
the at least one memory and computer program code configured, with the at least one processor, to cause the apparatus at least to perform:
receiving a secondary cell (SCell) activation command from a network node, wherein the secondary cell (SCell) activation command comprises an indication of at least one candidate secondary cell (SCell) targeted for activation;
determining a set of secondary cells (SCells) requested for activation that are available or preferred for activation; and
transmitting feedback to the network node, wherein the feedback comprises information on the available or preferred secondary cells (SCells) being activated.

70. The apparatus of claim 69, wherein the determining comprises determining each secondary cell (SCell) activation time and prioritizing the secondary cells (SCells) with reduced activation time based on the secondary cell (SCell) status.

71. The apparatus of claim 70, wherein the secondary cell (SCell) status comprises whether the secondary cell (SCell) is a known cell to the user equipment.

72. The apparatus of claim 69, wherein the indication indicates more secondary cells (SCells) to activate than needed, along with a minimum number of secondary cells (SCells) that the at least one user equipment (UE) should activate.

73. The apparatus of claim 69, wherein the receiving comprises receiving an uplink grant along with the secondary cell (SCell) activation command.

74. The apparatus of claim 69, wherein the secondary cell (SCell) activation command comprises a single or multiple secondary cell (SCell) activation medium access control (MAC)-control element (CE).

75. The apparatus of claim 69, wherein the transmitting of the feedback comprises transmitting the information jointly with a hybrid automatic repeat request (HARQ)-acknowledgment (ACK) of the secondary cell (SCell) activation command, informing the network node that the secondary cell (SCell) activation command was correctly received.

76. The apparatus of claim 69, wherein the transmitting of the feedback comprises transmitting the information in a next channel state information (CSI) feedback to be sent by the user equipment (UE).

77. The apparatus of claim 70, wherein the transmitting of the feedback comprises transmitting, via the uplink grant, layer 2 (L2) feedback with information on at least one of the secondary cells (SCells) that are available for activation or the user equipment's preferred list of secondary cells (SCells) to be activated.

78. The apparatus of claim 77, wherein the L2 feedback comprises:
a medium access control (MAC)-control element (CE) comprising a bitmap for each secondary cell (SCell) configured, wherein each field of the bitmap indicates available or preferred secondary cells (SCells) for activation.

79. The apparatus of claim 69, wherein the L2 feedback comprises:
a modified power headroom report (PHR) or modified power headroom report (PHR) trigger, wherein the power headroom report (PHR) comprises information on available or preferred secondary cells (SCells) for activation.

80. The apparatus of claim 69, wherein the transmitting of the L2 feedback comprises transmitting periodical or event based feedback on secondary cell (SCell) status or secondary cell (SCell) activation preference via medium access control (MAC)-control element (CE).

81. The apparatus of claim 80, wherein the transmitting of the event based feedback comprises transmitting the event based feedback in the medium access control (MAC)-control element (CE) as padding when allocated resources are larger than available data.

82. The apparatus of claim 80, wherein the user equipment (UE) is configured to prioritize the feedback based on its duration in discontinuous (DRX) active time and estimation of a need for higher downlink (DL) or uplink (UL) capacity.
